(19) United States
(12) Patent Application Publication
(10) Pub. No.: US 2025/0082534 A1
(43) Pub. Date: Mar. 13, 2025

(54) BODY BAG FOR USE IN ALKALINE HYDROLYSIS

(71) Applicant: Gateway Services Inc., Guelph (CA)

(72) Inventor: Martin Minajew, Guelph (CA)

(73) Assignee: Gateway Services Inc., Guelph, ON (CA)

(21) Appl. No.: 18/809,594

(22) Filed: Aug. 20, 2024

Related U.S. Application Data
(60) Provisional application No. 63/581,426, filed on Sep. 8, 2023.

(51) Int. Cl. A61G 17/007; A61G 17/06

(52) U.S. Cl. CPC A61G 17/0136; A61G 17/06; A61G 2205/10; A61G 2205/50; A61G 2205/60

(57) ABSTRACT

A sealable body bag is disclosed. The sealable body bag comprises a soluble component configured to be impermeable to body fluids, a leak-resistant sealing component; a permeable insoluble component, and an insoluble identification tag configured to identify the insoluble component.

### CROSS REFERENCE TO RELATED APPLICATIONS

This application claims priority to U.S. Provisional Patent Application Ser. No. 63/581,426 entitled “BODY BAG FOR USE IN ALKALINE HYDROLYSIS” filed on Sep. 8, 2023 under attorney docket number 100723-00004, the contents of which are incorporated herein by reference.

### FIELD OF THE INVENTION

The present invention relates generally to body bags and specifically to body bags for use in alkaline hydrolysis disposal of a corpse.

### BACKGROUND OF THE INVENTION

Alkaline hydrolysis (also referred to as aquamation) is a method of cremation that is available for corpses, both for humans and for animals. Aquamation uses water, alkaline chemicals, heat, and sometimes pressure and agitation, to accelerate natural decomposition, leaving remains including bone fragments and a neutral liquid called effluent. The liquid can be discharged and the remains can be processed into powder and stored in an urn, for example.

To facilitate handling and transport of the corpse, body bags have been designed to be durable, leak resistant, and to facilitate easy loading. To facilitate aquamation, the body bags have been further designed to be soluble.

Individual aquamation allows the remains to be returned. Each corpse is placed into its own individual basket or cage, which is then placed into an aquamation vessel. The baskets maintain separation between different remains, which can then be processed and stored. However, individual aquamation is costly as it is labour intensive and there are a limited number of baskets available in each aquamation vessel.

In contrast, communal aquamation, often used for animals, is less expensive than individual aquamation as multiple corpses are placed in the aquamation vessel without the need for baskets. However, communal aquamation precludes the ability to store the remains as different corpses cannot be disambiguated from each other.

It is an object of the present invention to obviate or mitigate at least some of the aforementioned disadvantages.

### SUMMARY

Embodiments of a body bag for use in alkaline hydrolysis are disclosed. In accordance with an aspect of an embodiment, there is provided a sealable body bag comprising: a soluble component configured to be impermeable to body fluids; a leak-resistant sealing component configured to seal the soluble component; and a permeable insoluble component.

The soluble component may further comprise a region on which an identifier can be written. The soluble component may further comprise an insoluble identification tag configured to identify the sealable body bag.

The insoluble identification tag may comprise an identification tag of an insoluble material. The insoluble identification tag may comprise an identification tag sealed in an insoluble pouch. The insoluble identification tag may be integrated with the insoluble component. The insoluble identification tag may be removably couplable with the insoluble component.

The insoluble identification tag may comprise a unique visible identifier. The unique visible identifier may comprise at least one of a serial number, a barcode, or a Quick Response code.

The insoluble identification tag may comprise a unique electronic identifier. The unique electronic identifier may comprises at least one of a Near Field Communication (NFC) tag, a Radio Frequency Identification (RFID) tag, or a Bluetooth® tag.

The sealable body bag may further comprise an external tag protruding from the body bag for receiving the insoluble identification tag. The external tag may be in the form of a label, a flap, or a handle. The external tag may comprise only the insoluble component.

The insoluble component of the sealable body bag may be embedded within the soluble component. The insoluble component may be attached to the soluble component. The insoluble component may be attached to the soluble component by adhesive or by stitching. The insoluble component may be sandwiched between two layers of the soluble component.

The leak-resistant sealing component of the sealable body bag may comprise at least one of a zipper, an adhesive strip, a Ziploc® strip, and a drawstring. The soluble component may be a durable and impermeable soluble bag. The insoluble component may be a mesh bag.

In accordance with another aspect, of an embodiment there is provided a method for processing remains during an alkaline hydrolysis process, the method comprising: placing a plurality of body bags into an alkaline hydrolysis vessel, each body bag including a soluble component configured to be impermeable to body fluids, a permeable insoluble component, a corpse within the permeable insoluble component, and an insoluble identification tag; after an alkaline hydrolysis process, removing the permeable insoluble component from the hydrolysis vessel, the permeable insoluble component containing the remains of the corpse; identifying the remains using the insoluble identification tag; and processing the remains accordingly.

The insoluble identification tag may be incorporated into the body bag. The insoluble identification tag may be added into the insoluble component prior to placing the body bag into an alkaline hydrolysis vessel. The insoluble identification tag may be associated with a soluble identification tag of the body bag prior to placing it into the alkaline hydrolysis vessel.

### BRIEF DESCRIPTION OF THE DRA WINGS

So that the manner in which the features and advantages of the embodiments are attained and can be understood in more detail, a more particular description can be had by reference to the embodiments that are illustrated in the appended drawings. However, the drawings illustrate only some embodiments and are not to be considered limiting in scope since there can be other equally effective embodiments.

It shall be noted that some of the details and/or features shown in the drawings herein may not be drawn to scale for clarity purposes.

Embodiments of the invention will now be described by way of example only with reference to the following drawings in which:

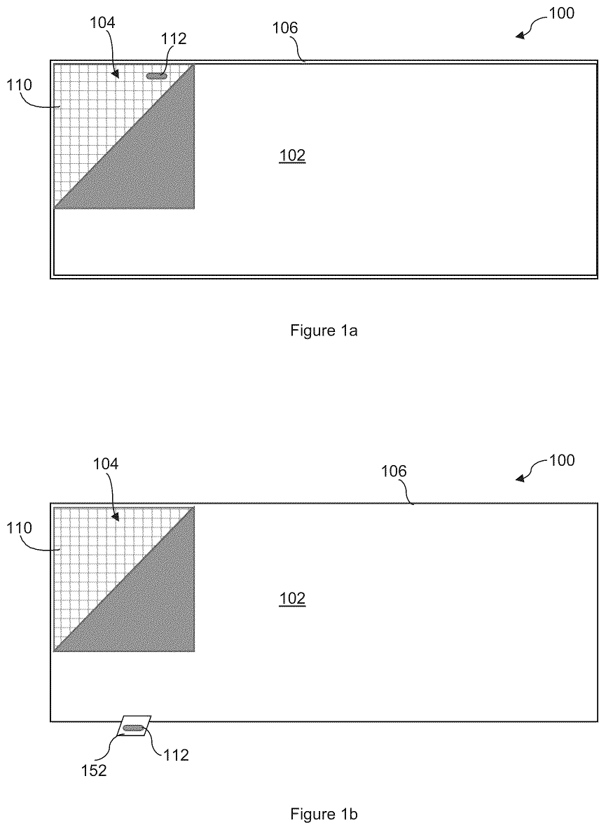

FIGS. 1a and 1b are example embodiments of a body bag in accordance with an aspect of an embodiment;

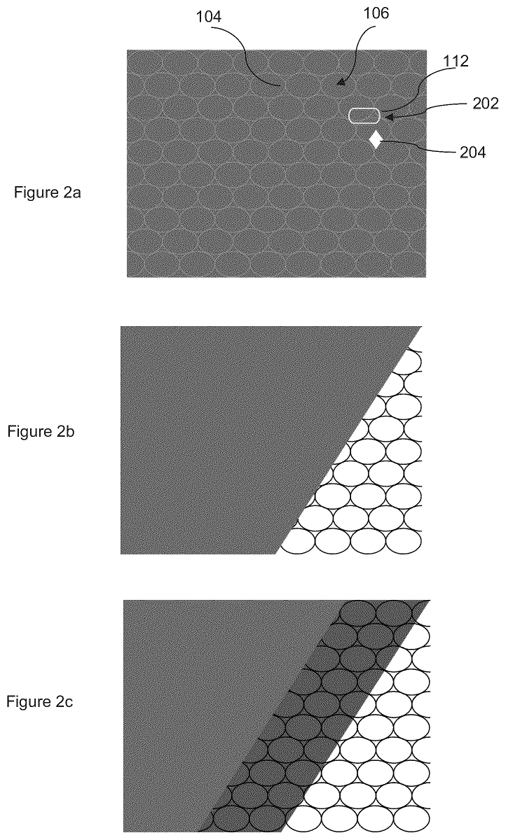

FIGS. 2a to 2d are example embodiments of different ways to integrate a soluble bag and a mesh bag 104 to form the body bag;

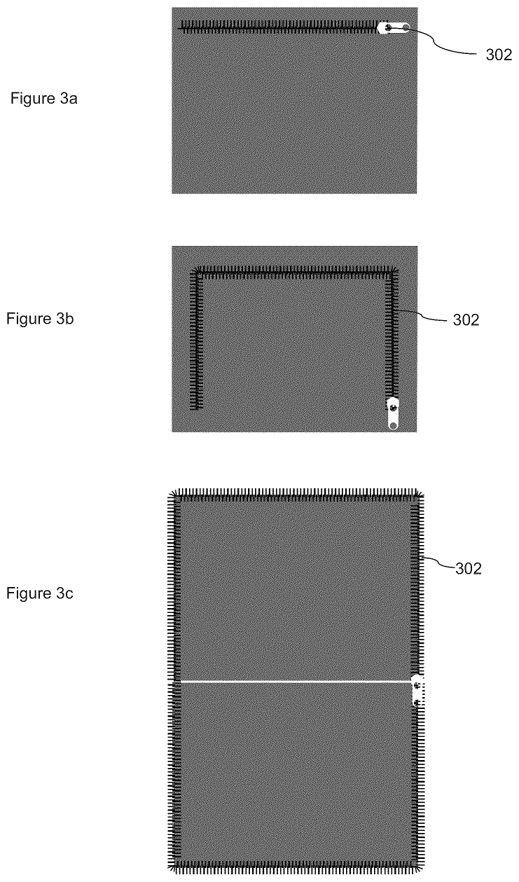

FIGS. 3a to 3c are example embodiments where a leak-resistant sealing component is a zipper;

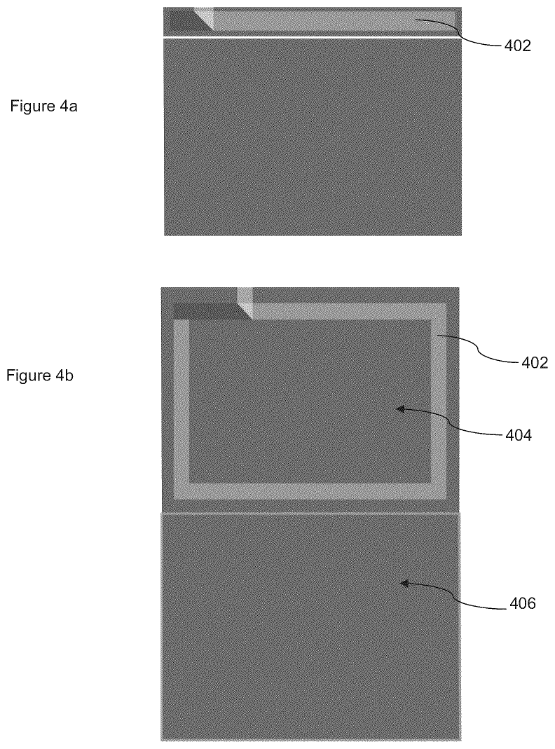

FIGS. 4a and 4b are example embodiments where the leak-resistant sealing component is an adhesive strip;

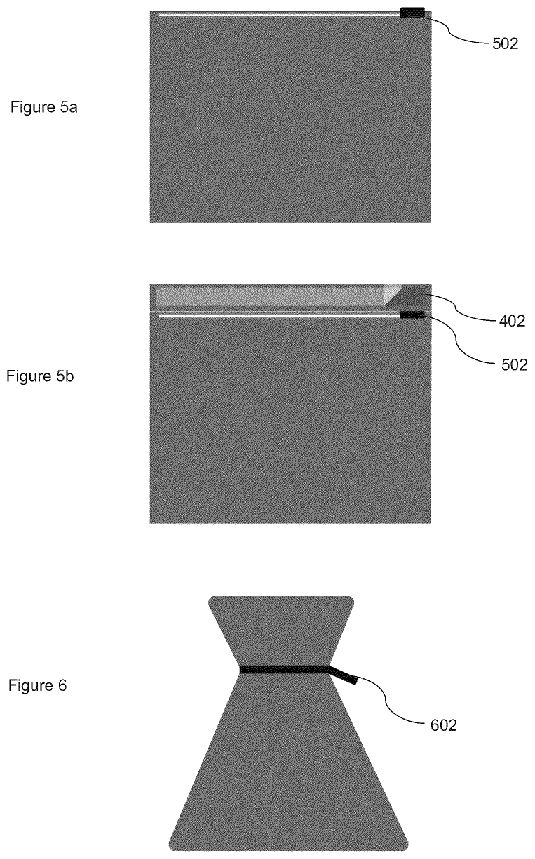

FIGS. 5a and 5b are example embodiments where the leak-resistant sealing component is a Ziploc® strip or slide seal;

FIG. 6 is an example embodiment where the leak-resistant sealing component is a draw string; and

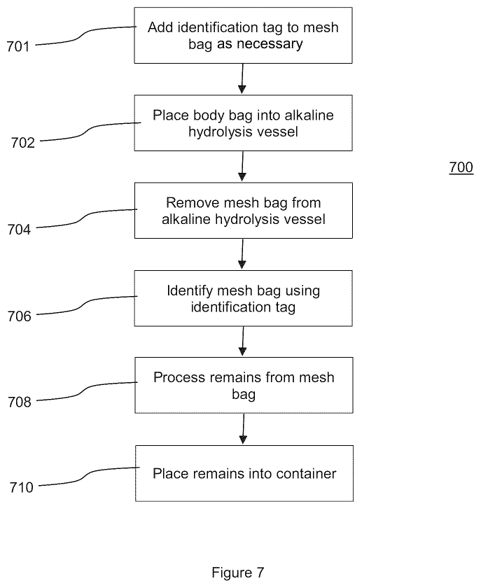

FIG. 7 is a flow chart illustrating an example embodiment of a method for processing remains during an alkaline hydrolysis process.

### DETAILED DESCRIPTION

The following discussion is directed to various embodiments of the present disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to imply that the scope of the disclosure, including the claims, is limited to that embodiment. Accordingly, various modifications and additions can be made to the exemplary embodiments discussed without departing from the scope of the present disclosure. For example, while the embodiments described below refer to particular features, the scope of this disclosure also includes embodiments having different combinations of features and embodiments that may not include all of the below described features. For convenience, like numerals in the description refer to like structures in the drawings.

FIG. 1a illustrates an example embodiment of a sealable body bag, represented generally by numeral 100. The body bag 100 is for use in alkaline hydrolysis processing of a corpse. The body bag 100 comprises a soluble component 102 and an insoluble component 104. The soluble component 102 is a bag that is durable and impermeable to bodily fluids to facilitate transport of the corpse. In an embodiment, the soluble bag 102 comprises an impermeable, soluble material. For the purpose of the present invention, soluble means dissolvable during an alkaline hydrolysis process. The soluble bag 102 may be temperature sensitive and dissolve in warm or hot fluid. In an example, a minimum fluid temperature may be defined, above which the soluble bag 102 dissolves. The minimum temperature reduces the likelihood that the soluble bag 102 will dissolve when accidentally exposed to fluid, such as rain or snow for example. As will be appreciated by a person skilled in the art, the minimum temperature may vary depending on the environment in which the body bag 100 is being handled.

To inhibit fluids leaking from the body bag 100, the soluble bag 102 comprises a leak-resistant sealing mechanism 106. The transparency of the soluble component 102 can range from translucent to opaque. The soluble bag 102 may be coloured and/or otherwise decorated.

An example of a soluble bag 102 is the Classic PVA Alkaline Hydrolysis Body Bag provided by Classic Plastics Corporation. This particular bag is designed for alkaline hydrolysis at a temperature of 150° F. or higher. As will be appreciated other body bags may be available or be developed for use at the same or different temperatures.

In an embodiment, the insoluble component 104 comprises a permeable insoluble material. For the purpose of the present invention, insoluble means that the insoluble component 104 substantially maintains its integrity during the alkaline hydrolysis process. In an embodiment, the insoluble component 104 comprises a permeable bag, such as a mesh bag. The mesh bag 104 may be made of nylon or other material that can substantially maintain its integrity during the alkaline hydrolysis process. The mesh bag 104 comprises a plurality of openings 110. Each of the openings 110 may be the same size or they may be different sizes. The openings are shaped and sized to permit the passage of fluid but inhibit the passage of the remains during the alkaline hydrolysis process.

In an embodiment, the body bag 100 may further comprise an identification tag 112. The identification tag 112 is insoluble. The identification tag 112 is used to identify the mesh bag 104 after the alkaline hydrolysis process is complete, thereby identifying the body bag 100 and the remains. The identification tag 112 may be integrated with the insoluble component 104. Alternatively, the identification tag 112 may be removably coupled to the insoluble component 104. A removably coupled identification tag 112 may be disposable or reusable. The identification tag 112 may be identifiable by a unique visible indicator, such as a serial number, a barcode, a Quick Response (QR) code, or the like. Alternatively, the identification tag 112 may be identifiable using a unique electronic tag such as a Near Field Communication (NFC) tag, a Radio Frequency Identification (RFID) tag, a Bluetooth® tag, or the like. In an embodiment, the electronic identification tag 112 itself may be an insoluble material. In another embodiment, the electronic identification tag 112 may be sealed in an insoluble pouch.

In an embodiment, the body bag 100 may not comprise the identification tag 112. For example, the body bag 100 may include a defined region on which an identifier can be written using a pen or other writing utensil. In another example, the identifier can be written onto a sticker or other adhesive, which is then applied to the body bag 100. As will be appreciated, such identifiers on the body bag 100 may be soluble.

The soluble bag 102 and the mesh bag 104 can be integrated in a number of different ways to form the body bag 100. FIG. 2a illustrates an example embodiment in which the mesh bag 104 may be embedded within the soluble bag 102. Embedding the mesh bag 104 within the soluble bag 102 may protect the mesh bag 104 from physical damage. Further, embedding the mesh 104 within the soluble bag 102 may improve the durability of the body bag 100 as a whole.

Depending on the translucency of the soluble bag 102, the mesh bag 104 may not be easily distinguishable, visually, from the soluble bag 102 prior to the alkaline hydrolysis process. Accordingly, in an embodiment, a predefined identifier location 202 is established for the body bag 100. An electronic identification tag 112 is coupled with the mesh bag 104 and embedded within the soluble bag 102 so that it is positioned proximal the predefined identifier location 202. The soluble bag 102 may further include a marking 204 proximal the predefined identifier location 202, so that it is easily identifiable prior to the alkaline hydrolysis process. The marking 204 may comprise a predefined colour patch, a logo, a symbol, or other graphical or textual representation.

In an alternative embodiment, the identification tag 112 may be coupled with the soluble bag 102 after the mesh bag 104 has been embedded therewith. The identification tag 112 may be coupled to a coupling, such as a ring for example. The coupling may then be coupled to the mesh bag 104 through the soluble bag 102. For example, the coupling may pierce the soluble bag 102 and wrap around a strand of the mesh bag 104. The point or points at which the soluble bag 102 may be pierced may need to be reinforced to inhibit bodily fluid from leaking there through.

FIG. 1b illustrates another example embodiment of the sealable body bag. In the illustrated embodiment, an external tag 152 may be provided on the body bag 100. The external tag may protrude from the body bag 100. The external tag 152 may take the form of a label, a flap, a handle, or the like. The external tag 152 may comprise a portion of the mesh bag 104 embedded within the soluble bag 102. Alternatively, the external tag 152 may comprise only the mesh bag 104. The identification tag 112 may be coupled to the external tag 152 of the body bag 100, either directly or via the coupling.

FIG. 2b illustrates an example embodiment in which the mesh bag 104 may be attached to the soluble bag 102. The mesh bag 104 may be attached to the soluble bag 102 by means of an adhesive, stitching, or the like. The identification tag 112 may be coupled to the mesh bag 104 in a similar manner to that described above.

FIG. 2c illustrates an example embodiment in which the mesh bag 104 may be sandwiched between two layers of the soluble bag 102. The layers of the soluble bag 102 and the mesh bag 104 may be attached by means of adhesive, stitching, or the like. The identification tag 112 may be coupled to the mesh bag 104 in a similar manner to that described above.

In an alternate embodiment, the mesh bag 104 and the soluble bag 102 may be separate bags. In this embodiment, the corpse may be placed into the mesh bag 104. The mesh bag 104 may then be placed into the soluble bag 102. Alternatively, the corpse may be placed into the soluble bag 102. The soluble bag 102 may be placed into the mesh bag 104 prior to the hydrolysis process. The identification tag 112 may be coupled to the mesh bag 104 in a similar manner to that described above.

FIGS. 3a to 3c illustrate example embodiments of the soluble bag 102 in which the leak-resistant sealing component 106 comprises a zipper 302. As illustrated in FIG. 3a, the zipper 302 may be placed proximal an edge along a length of the soluble bag 102. Opening the zipper 302 creates an opening in the body bag 100, in which the corpse may be placed. Closing the zipper 302 seals the body bag 100. As illustrated in FIG. 3b, the zipper 302 may be placed proximal the edge along three sides of the soluble bag 102. Opening the zipper 302 opens a flap in the body bag 100, in which the corpse may be placed. Closing the zipper 302 seals the body bag 100. As illustrated in FIG. 3c, the zipper 302 may be placed at the edge along three sides of the soluble bag 102. Opening the zipper 302 opens the body bag 100, in which the corpse may be placed. Closing the zipper 302 seals the body bag 100.

FIGS. 4a and 4b illustrate example embodiments of the soluble bag 102 in which the leak-resistant sealing component 106 comprises an adhesive strip 402. As illustrated in FIG. 4a, the adhesive strip 402 may be placed proximal an opening in the soluble bag 102. Once the corpse is placed into the body bag 100, the adhesive strip 402 is folded or otherwise manipulated to adhere to another portion of the soluble bag 102 and seal the body bag 100. As illustrated in FIG. 4b, the adhesive strip 402 may be placed on a portion of the soluble bag 102 such that it creates an enclosed surface area 404. The corpse may be placed into the enclosed surface area 404. The remaining portion 406 of the soluble bag 102 may be folded or otherwise manipulated over the corpse and adhered to the adhesive strip 402 and seal the body bag 100.

FIGS. 5a and 5b illustrate example embodiments of the soluble bag 102 in which the leak-resistant sealing component 106 comprises a Ziploc® strip or slide and seal 502. As illustrated in FIG. 5a, the Ziploc® strip or slide and seal 502 may be placed proximal an edge along a length of the soluble bag 102. Opening the Ziploc® strip or slide and seal 502 creates an opening in the body bag 100, in which the corpse may be placed. Closing the Ziploc® strip or slide and seal 502 seals the body bag 100. As illustrated in FIG. 5b, an adhesive strip 402 may be placed proximal an edge along a length of the soluble bag 102. The adhesive strip 402 may be placed between the Ziploc® strip or slide and seal 502 and the edge. Opening the Ziploc® strip or slide and seal 502 creates an opening in the body bag 100, in which the corpse may be placed. Closing the Ziploc® strip or slide and seal 502 seals the body bag 100. Once the Ziploc® strip or slide and seal 502 is closed the adhesive strip 402 may be folded over the Ziploc® strip or slide and seal 502 and adhered to another portion of soluble bag 102 to further seal the body bag 100.

FIG. 6 illustrates an example embodiment of the soluble bag 102 in which the leak-resistant sealing component 106 comprises a drawstring 602.

FIG. 7 illustrates an example embodiment of a method for processing remains during an alkaline hydrolysis process, which is represented generally by numeral 700. At block 701, if the body bag 100 includes a soluble identification tag 112 or other soluble identifier, a temporary insoluble identification tag is added to the mesh bag 104. The temporary insoluble identification tag is correlated with the soluble identifier of the body bag 100 to which it is added. For example, the temporary insoluble identification tag may comprise a metal disc with an identification number. The identification number of the metal disc is recorded as being associated with the body bag 100 and the soluble identification tag 112 or other soluble identifier on the body bag. The metal disc may be reused for subsequent processes. At block 702, the body bag 100, including the corpse, may be placed directly into an alkaline hydrolysis vessel. At block 704, after the alkaline hydrolysis process, the remaining mesh bag 104 and the remains contained therein may be removed from the alkaline hydrolysis vessel. At block 706, the mesh bag 104 is identified using the identification tag 112. At block 708, the remains from the insoluble component may be processed. At block 710, the processed remains may be placed into a storage container. The storage container into which the remains are place may depend on the identity of the mesh bag 104.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Also, the use of “a” or “an” is employed to describe elements and components described herein. This is done merely for convenience and to give a general sense of the scope of the invention. This description should be read to include one or at least one and the singular also includes the plural unless it states otherwise.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

### CLAUSES

Clause 1. A sealable body bag comprising:
a soluble component configured to be impermeable to body fluids;
a leak-resistant sealing component configured to seal the soluble component; and
a permeable insoluble component.

Clause 2. The sealable body bag of clause 1, wherein the soluble component further comprises a region on which an identifier can be written.

Clause 3. The sealable body bag of clause 1, further comprising an insoluble identification tag configured to identify the sealable body bag.

Clause 4. The sealable body bag of clause 3, wherein the insoluble identification tag comprises an identification tag of an insoluble material.

Clause 5. The sealable body bag of clause 3, wherein the insoluble identification tag comprises an identification tag sealed in an insoluble pouch.

Clause 6. The sealable body bag of any one of clauses 3 to 5, wherein the insoluble identification tag is integrated with the insoluble component.

Clause 7. The sealable body bag of any one of clauses 3 to 5, wherein the insoluble identification tag is removably couplable with the insoluble component.

Clause 8. The sealable body bag of any one of clauses 3 to 7, wherein the insoluble identification tag comprises a unique visible identifier.

Clause 9. The sealable body bag of clause 8, wherein the unique visible identifier comprises at least one of a serial number, a barcode, or a Quick Response code.

Clause 10. The sealable body bag of any one of clauses 3 to 7, wherein the insoluble identification tag comprises a unique electronic identifier.

Clause 11. The sealable body bag of clause 10, wherein the unique electronic identifier comprises at least one of a Near Field Communication (NFC) tag, a Radio Frequency Identification (RFID) tag, or a Bluetooth® tag.

Clause 12. The sealable body bag of clause 3 further comprising an external tag protruding from the body bag for receiving the insoluble identification tag.

Clause 13. The sealable body bag of clause 12, wherein the external tag is in the form of a label, a flap, or a handle.

Clause 14. The sealable body bag of clause 12 or clause 13, wherein the external tag comprises only the insoluble component.

Clause 15. The sealable body bag of any one of clauses 1 to 14, wherein the insoluble component is embedded within the soluble component.

Clause 16. The sealable body bag of any one of clauses 1 to 14, wherein the insoluble component is attached to the soluble component.

Clause 17. The sealable body of clause 16, wherein the insoluble component is attached to the soluble component by adhesive or by stitching.

Clause 18. The sealable body bag of any one of clauses 1 to 14, wherein the insoluble component is sandwiched between two layers of the soluble component.

Clause 19. The sealable body bag of any one of clauses 1 to 18, wherein the leak-resistant sealing component comprises at least one of a zipper, an adhesive strip, a Ziploc® strip, and a drawstring.

Clause 20. The sealable body bag of any one of clauses 1 to 19, wherein the soluble component is a durable and impermeable soluble bag.

Clause 21. The sealable body bag of any one of clauses 1 to 20, wherein the insoluble component is a mesh bag.

Clause 22. A method for processing remains during an alkaline hydrolysis process, the method comprising:
placing a plurality of body bags into an alkaline hydrolysis vessel, each body bag including a soluble component configured to be impermeable to body fluids, a permeable insoluble component, a corpse within the permeable insoluble component, and an insoluble identification tag;
after an alkaline hydrolysis process, removing the permeable insoluble component from the hydrolysis vessel, the permeable insoluble component containing the remains of the corpse;
identifying the remains using the insoluble identification tag; and
processing the remains accordingly.

Clause 23. The method of clause 22, wherein the insoluble identification tag is incorporated into the body bag.

Clause 24. The method of clause 22, wherein the insoluble identification tag is added into the insoluble component prior to placing the body bag into an alkaline hydrolysis vessel.

Clause 25. The method of clause 22, wherein the insoluble identification tag is associated with a soluble identification tag of the body bag prior to placing it into the alkaline hydrolysis vessel.

What is claimed is:

1. A sealable body bag comprising:
a soluble component configured to be impermeable to body fluids;
a leak-resistant sealing component configured to seal the soluble component; and
a permeable insoluble component.

2. The sealable body bag of claim 1, wherein the soluble component further comprises a region on which an identifier can be written.

3. The sealable body bag of claim 1, further comprising an insoluble identification tag configured to identify the sealable body bag.

4. The sealable body bag of claim 3, wherein the insoluble identification tag comprises an identification tag of an insoluble material.

5. The sealable body bag of claim 3, wherein the insoluble identification tag comprises an identification tag sealed in an insoluble pouch.

6. The sealable body bag of claim 3, wherein the insoluble identification tag is integrated with the insoluble component.

7. The sealable body bag of claim 3, wherein the insoluble identification tag is removably couplable with the insoluble component.

8. The sealable body bag of claim 3, wherein the insoluble identification tag comprises a unique visible identifier.

9. The sealable body bag of claim 8, wherein the unique visible identifier comprises at least one of a serial number, a barcode, or a Quick Response code.

10. The sealable body bag of claim 3, wherein the insoluble identification tag comprises a unique electronic identifier.

11. The sealable body bag of claim 10, wherein the unique electronic identifier comprises at least one of a Near Field Communication (NFC) tag, a Radio Frequency Identification (RFID) tag, or a Bluetooth® tag.

12. The sealable body bag of claim 3 further comprising an external tag protruding from the body bag for receiving the insoluble identification tag.

13. The sealable body bag of claim 12, wherein the external tag is in the form of a label, a flap, or a handle.

14. The sealable body bag of claim 12, wherein the external tag comprises only the insoluble component.

15. The sealable body bag of claim 1, wherein the insoluble component is embedded within the soluble component.

16. The sealable body bag of claim 1, wherein the insoluble component is attached to the soluble component.

17. The sealable body of claim 16, wherein the insoluble component is attached to the soluble component by adhesive or by stitching.

18. The sealable body bag of claim 1, wherein the insoluble component is sandwiched between two layers of the soluble component.

19. The sealable body bag of claim 1, wherein the leak-resistant sealing component comprises at least one of a zipper, an adhesive strip, a Ziploc® strip, and a drawstring.

20. The sealable body bag of claim 1, wherein the soluble component is a durable and impermeable soluble bag.

21. The sealable body bag of claim 1, wherein the insoluble component is a mesh bag.

22. A method for processing remains during an alkaline hydrolysis process, the method comprising:
placing a plurality of body bags into an alkaline hydrolysis vessel, each body bag including a soluble component configured to be impermeable to body fluids, a permeable insoluble component, a corpse within the permeable insoluble component, and an insoluble identification tag;
after an alkaline hydrolysis process, removing the permeable insoluble component from the hydrolysis vessel, the permeable insoluble component containing the remains of the corpse;
identifying the remains using the insoluble identification tag; and
processing the remains accordingly.

23. The method of claim 22, wherein the insoluble identification tag is incorporated into the body bag.

24. The method of claim 22, wherein the insoluble identification tag is added into the insoluble component prior to placing the body bag into an alkaline hydrolysis vessel.

25. The method of claim 22, wherein the insoluble identification tag is associated with a soluble identification tag of the body bag prior to placing it into the alkaline hydrolysis vessel.
